(19) United States
(12) Patent Application Publication
(10) Pub. No.: US 2012/0095719 A1
(43) Pub. Date: Apr. 19, 2012

(54) MEMORY THERMAL MANAGEMENT BASED ON SLOT INFORMATION

(75) Inventors: NAOYUKI ARAKI, KANAGAWA-KEN (JP); SHINJI MATSUSHIMA, KANAGAWA-KEN (JP); TAKUROH KAMIMURA, KANAGAWA-KEN (JP)

(73) Assignee: LENOVO (SINGAPORE) PTE. LTD.

(21) Appl. No.: 12/907,635

(22) Filed: Oct. 19, 2010

(51) Int. Cl. G01K 13/00; G06F 12/00; G06F 15/177

(52) U.S. Cl. 702/130; 713/2; 711/154; 711/E12.001

(57) ABSTRACT

An apparatus comprises a mother board, a memory slot on the motherboard, a thermal sensor, and an embedded controller. The thermal sensor may detect temperature of a memory module on the memory slot. The embedded controller may monitor temperature from the detector. A memory controller may be adapted to receive data from the embedded controller. A computing device comprises a mother board, a basic input/output system (BIOS), and a memory controller. The basic input/output system may be disposed on the mother board. The memory controller may be adapted to receive data from the BIOS regarding a quantity and a quality of memory installed in the computing device. The memory controller may be adapted to regulate bandwidth of memory access of a memory module.

### BACKGROUND OF THE INVENTION

The present invention relates generally to the field of thermal management and, more specifically, to methods and apparatus for thermal management of memory modules by using a thermal sensor.

Heat management is an important consideration in the design of modern-day computer systems, especially portable computers such as notebook-sized personal computers (hereinafter referred to as “notebook PCs”). Currently, with increasing of memory size and throughput speed, memory temperature control is an issue. If the temperature of the memory is too high, the data stored in the memory may be corrupted or lost. In addition, the memory itself may be damaged by excessively high temperatures.

Currently, a thermal sensor may be located on the memory controller. When temperature gets high, the memory controller will issue a command to suppress the memory bandwidth to prevent excessive heating. However, too much bandwidth suppression may hinder performance of the computer system. In addition, the thermal sensor on the memory controller does not accurately record the temperature of the memory module in the memory slot and has a high error margin.

Therefore, it can be seen that there is a need for apparatus and methods for an efficient memory thermal management system in notebook PCs.

### SUMMARY

In one aspect, an apparatus comprises a mother board, a memory slot on the mother board; a thermal sensor detecting temperature of a memory module on the memory slot, wherein the thermal sensor is disposed on the motherboard; a controller monitoring temperature from the thermal sensor; and a memory controller adapted to receive data from the embedded controller.

In another aspect, a method comprises retrieving memory slot information; computing at least one temperature threshold value for a memory module on a memory slot based on the retrieved memory slot information; and regulating bandwidth of the memory access for the memory module based on the temperature threshold value.

In a further aspect, a computing device comprises a mother board; a basic input/output system (BIOS) disposed on the mother board; and a memory controller adapted to receive data, from the BIOS, regarding a quantity and a quality of memory installed in the computing device, the memory controller adapted to regulate bandwidth of memory access of a memory module.

These and other features, aspects and advantages of the present invention will become better understood with reference to the following drawings, description and claims.

### BRIEF DESCRIPTION OF THE DRAWINGS

FIG. 1 is a perspective view illustrating a notebook PC according to an exemplary embodiment;

FIG. 2 is a schematic block diagram illustrating a configuration of a notebook PC according to an exemplary embodiment;

FIG. 3 is a plan view of an exemplary embodiment of a mother board adapted for use in the notebook PC as shown in FIG. 1; and

FIG. 4 is a flow diagram illustrating an initialization process of an exemplary embodiment.

### DETAILED DESCRIPTION OF EMBODIMENTS

The following detailed description is of the best currently contemplated modes of carrying out exemplary embodiments. The description is not to be taken in a limiting sense, but is made merely for the purpose of illustrating the general principles, since the scope of the embodiments is best defined by the appended claims.

Various inventive features are described below that can each be used independently of one another or in combination with other features.

Broadly, exemplary embodiments provide methods and apparatus for thermal management of memory modules using a thermal sensor on a mother board. More specifically, exemplary embodiments of the memory thermal management system provide the thermal sensor close to a memory slot. In an exemplary embodiment, an embedded controller uses the thermal sensor to monitor the temperature of a memory module in the memory slot. During the power up initialization process, exemplary embodiments retrieve information concerning memory module configuration, such as memory type, size, and which memory slot is used. Based on the retrieved information, a basic input output system (BIOS) may set a trip point, such as a threshold temperature. When the threshold temperature has been reached, a memory controller may suppress the memory bandwidth to prevent excessive heating.

Exemplary embodiments may take the form of an entire hardware embodiment, or an embodiment combining software and hardware aspects. Exemplary embodiments are described below with reference to flowchart illustrations and/or block diagrams of methods, apparatus (systems) and computer program products.

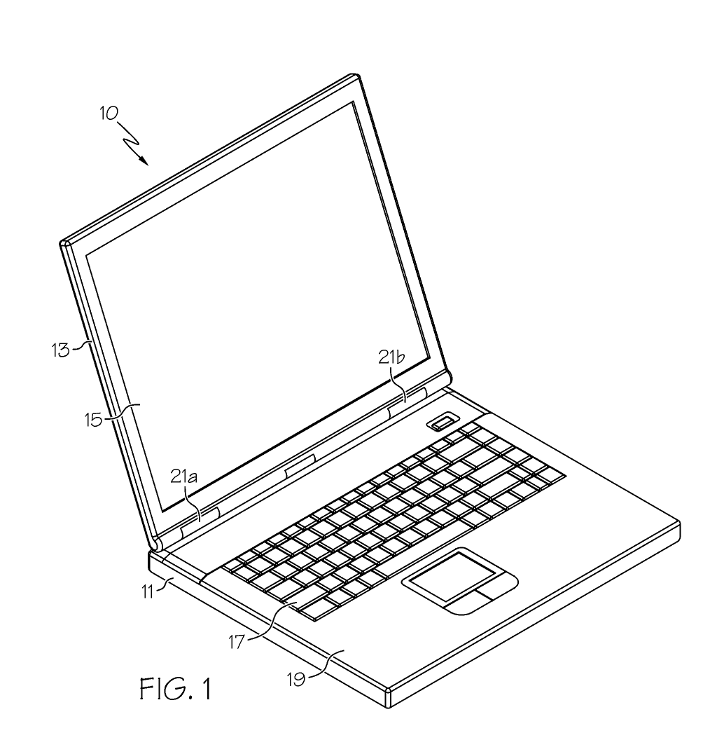

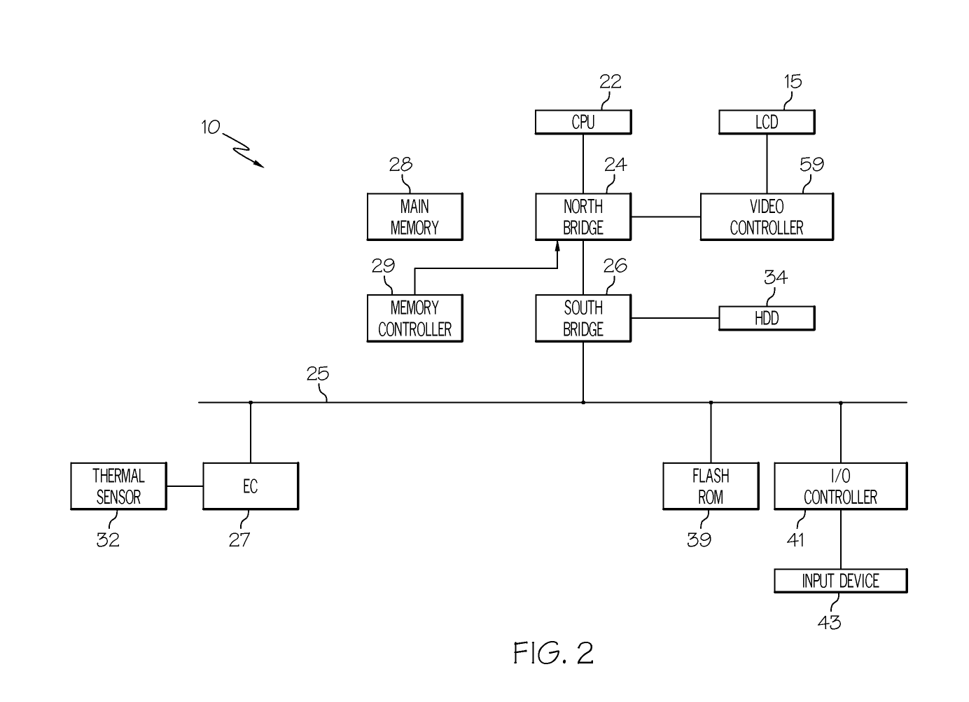

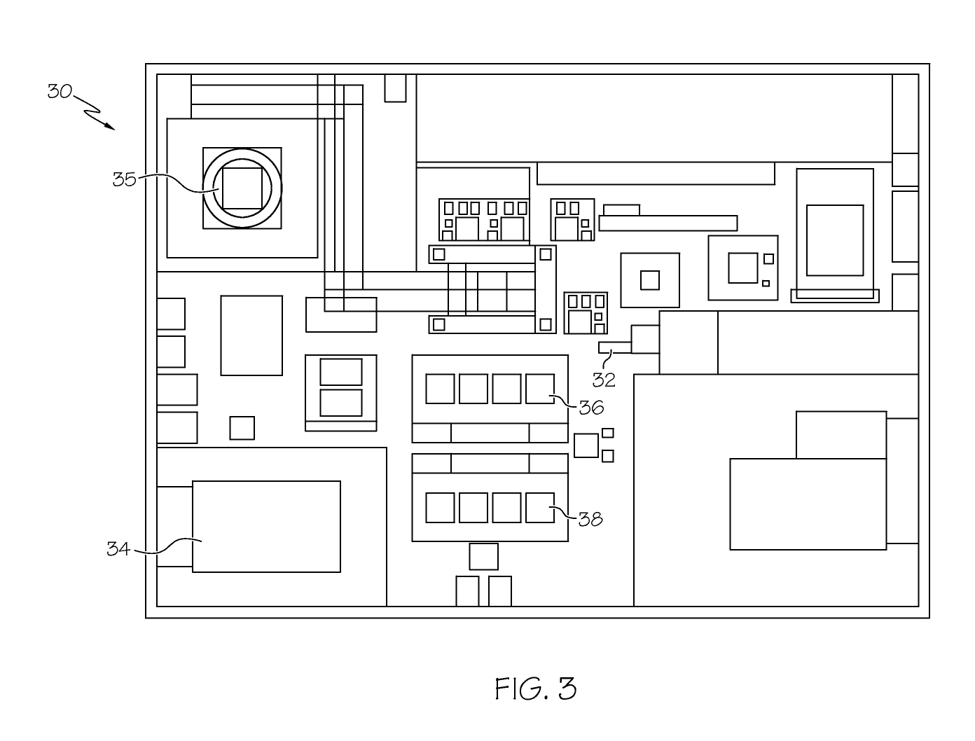

FIG. 1 is a perspective view illustrating a notebook PC 10 according to an exemplary embodiment. The notebook PC 10 may be a laptop computer system, such as one of the ThinkPad® series of personal computers sold by Lenovo (US) Inc. of Morrisville, N.C., or a workstation computer, such as the ThinkStation®, which is sold by Lenovo (US) Inc. of Morrisville, N.C. The notebook PC 10 may have a liquid crystal display (LCD) 15 accommodated in a display casing 13. A system casing 11 may accommodate system devices, such as a processor 35 (see FIG. 3), a motherboard 30 (see FIG. 3) and a hard disk drive 34 (see FIG. 2 and FIG. 3). A keyboard assembly 17 and a keyboard bezel 19 may be mounted on an upper surface of the system casing 11. The system casing 11 and the display casing 13 may be openably coupled to each other via hinge portions 21a and 21b.

FIG. 2 shows a schematic block diagram illustrating a configuration of the notebook PC 10 according to an exemplary embodiment with an architecture that may vary depending on manufacturer (e.g., INTEL®, AMD®, etc.). A central processing unit (CPU) 22 may execute an operating system (OS), a basic input/output system (BIOS), a device driver, or application programs. The CPU 22 may control a north bridge 24 and various devices connected to the north bridge 24 via various buses. A memory controller 29 may be included in the north bridge 24. The north bridge 24 may include memory controller functions for controlling an operation of accessing a main memory 28, a data buffer function for absorbing a difference in a data transfer rate between the CPU 22 and other device, and the like. The main memory 28 may be a volatile random access memory (RAM) used as a read area of programs executed by the CPU 22 and as a work area to which processed data may be written. A video controller 59 may be connected to the north bridge 24 for interaction with a liquid crystal display (LCD) 15.

A south bridge 26 may be connected to the north bridge 24. The south bridge 26 may be provided with a universal serial bus (USB), a serial ATA (AT Attachment), a serial peripheral interface (SPI) bus, a peripheral component interconnect (PCI) bus, a PCI-Express bus, and the like, and connected to devices corresponding thereto. A hard drive disk (HDD) 34 may be connected to the serial ATA port of the south bridge 26. In the HDD 34, an OS, a device driver, an application program, and the like may be stored.

The south bridge 26 may also be connected, via a LPC bus 25, to legacy devices which do not require high-speed data transmission. The LPC bus 25 may be connected to an embedded controller (EC) 27, a flash ROM 39, an I/O controller 41, and the like. The embedded controller (EC) 27 may be a micro computer chip configured by an 8 to 16 bit CPU, a ROM, a RAM, and the like, and may be further provided with an multi-channel analog to digital (A/D) input terminal, a multi-channel digital-to-analog (D/A) output terminal, a timer, and a digital input/output terminal.

The EC 27 may be connected to a thermal sensor 32. The thermal sensor 32 may be any of a wide variety of thermal sensors. In one exemplary embodiment, the thermal sensor 32 may be a thermal diode, for example. In another exemplary embodiment, thermal sensor 32 may be temperature sensors, having digital to analog converter (DAC) to provide selection of a temperature threshold reference and notification that the temperature threshold has been reached. The EC 27 may communicate with the thermal sensor 32 to acquire detected temperature data from the thermal sensor 32. The term “temperature data” broadly refers to digitized information that provides an indication of device temperature. The EC 27 then may relay the received temperature to the memory controller 29. The memory controller 29 may decide how to regulate the memory module access rate based on the received temperature.

The flash ROM 39 may be a nonvolatile memory in which stored contents may be electrically rewritable. The flash ROM may store a system BIOS and a power-on self test (POST) for performing tests or initializing hardware components during activation of the notebook PC 10. The I/O controller 41 may be connected to an input device 43 such as a keyboard or a mouse.

FIG. 3 illustrates a plan view of an exemplary embodiment of a motherboard 30 adapted for use in the notebook PC 10. For ease of illustration, only two memory slots 36, 38 and one thermal sensor 32, such as a temperature sensor, for example, are shown. In another exemplary embodiment, two memory slots and two detectors may be used. The first memory slot 36 may be disposed in parallel to the second memory slot 38, with the thermal sensor located in the vicinity of the first memory slot 36 on the mother board 30. In some embodiments, the thermal sensor may be located within about 0.25 to 1.5 inches from the first memory slot 36, typically from about 0.25 to 1 inch from the first memory slot 36. In some embodiments, the thermal sensor will be located closer to the first memory slot 36 than the second memory slot 38. A wide variety of memory modules (not shown) may fit to the memory slots 36 and 38. The memory modules may include conductive traces laminated onto a non-conductive substrate (e.g. a printed circuit board (PCB)). Examples of memory modules may include dual in line memory modules (DIMMs) and small outline DIMMs (SO-DIMMs).

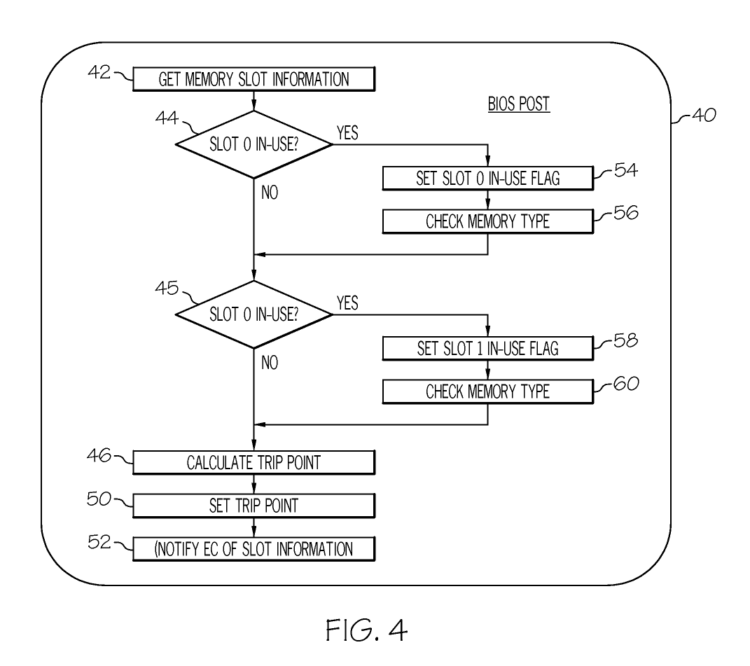

FIG. 4 illustrates a flow diagram illustrating an initialization process, such as BIOS POST of an exemplary embodiment. The BIOS may initialize a memory controller (MC) and an embedded controller (EC) during the POST. Process 40 may begin with block 42 where memory slot information may be obtained upon booting of a computer, system, server, etc, for example. In block 44, it may be determined whether the first memory slot 36 (shown in FIG. 3), namely Slot 0, is in use or not. In block 54, if it is determined that the Slot 0 is in-use, the Slot 0 in-use may be flagged. The process 40 may continue with block 56 where the memory type may be checked. In block 45, it may be determined whether the second memory slot 38 (shown in FIG. 3), namely Slot 1, is in-use or not. If it is determined that the Slot 1 is in-use, the Slot 1 in-use may be flagged in block 58. The process 40 may continue with block 60 where the memory type may be checked.

In block 46, a “trip point” may be calculated based on various factors, such as memory module information and thermal sensor information, for example. The memory module information may include at least one of memory type, size, frequency, source of vendor, platform, and distance between the memory slots. The thermal sensor information may include at least one of the thermal sensor type, size, frequency, source of vendor, platform, and distance between the memory slots and the thermal sensor. The “trip point” may refer to a threshold value that provides a thermal threshold for the memory module. The trip point may provide a mechanism for the memory controller to regulate bandwidth of memory access for the memory module. When the temperature surpasses the trip point, a certain events may be triggered. The various factors in calculating the trip point may be system dependent. In an exemplary embodiment, distance between the temperature sensor and the memory slots, such as Slot 0 and Slot 1, may be factored in while calculating the trip point. In an exemplary embodiment, the trip point may also be based on three scenarios—a memory module is in Slot 0; a memory module is in Slot 1; or memory modules are in both Slot 0 and Slot 1. When Slot 0 is used, the trip point for Slot 0 may be higher than the trip point for Slot 1, when Slot 1 is occupied, because the thermal sensor is closer to Slot 0 than Slot 1. If both slots are occupied, the trip point may be the highest because the heat generated by both memory modules in both slots tend to be higher than one single memory module in one slot. Therefore, the trip points may vary depending on the usage of memory slots. Memory modules may be replaced by a user and the trip point may be determined each time the computer is started, based on the BIOS′ determination of memory type. The memory type may include, memory size, memory frequency, source of vendor, chip position on memory module, raw chip card types, for example. The effect of these factors may vary from platform to platform.

In an exemplary embodiment, the following equation may be used for calculating the trip point Ts.

T_{S}=T_{b}+T₀(F₀×S₀×R₀×C₀)+T₁(F₁×S₁×R₁×C₁)

wherein
T_{b} is a base trip point, which is measured on an actual system or calculated based on the spec, such as factory configuration, for example;
T₀ and T₁ are base temperature and are measured on actual system for Slot 0 and Slot 1 respectively;
F₀ and F₁ are frequency factors for Slot 0 and Slot 1 respectively;
S₀ and S₁ are capacity factors for Slot 0 and Slot 1 respectively;
R₀ and R₁ are chip count (on memory module) factors for Slot 0 and Slot 1 respectively; and
C₀ and C₁ are correction factors for Slot 0 and Slot 1 respectively.

A plurality of trip points may be supported by a computing system. Each of multiple trip points may be set to enhance system performance and reliability. In an exemplary embodiment, depending on chip manufacturer, three trip points, such as cold, warm, and hot, for example, may be set on the memory controller. When the temperature surpasses the cold trip point, the memory controller may send a command to limit memory throughput. When the temperature surpasses the warm point, the memory controller may send a command to further reduce the memory throughput. When the temperature surpasses the hot trip point, the memory controller may further cut the memory throughput.

Still in FIG. 4, after calculating trip point in block 50, the process 40 may continue in block 50 where BIOS may set the trip points. In block 52, the slot information may be notified to the embedded controller (EC 27 in FIG. 2).

In an exemplary embodiment, after the POST, the embedded controller may monitor the temperature on the thermal sensor at a predetermined time period. The embedded controller may relay the collected temperature data to a memory controller. The collected temperature data value may be stored in the memory controller and may be compared to the computed temperature threshold value. If the temperature threshold has been reached, the memory controller may initiate a thermal control mechanism which may control the temperature of a memory device or a group of memory devices.

The thermal control mechanism may include a software based event and/or an automatic memory bandwidth throttle response. The software may include interrupts, system management interrupt (SMI), or even a system self-shut down. The thermal management mechanism may use the system self-shut down to avoid catastrophic damage and/or data loss if prior thermal control mechanisms (data rate throttling, software events, for example,) are not sufficiently effective in curbing the rise in temperature.

It should be understood, of course, that the foregoing relate to exemplary embodiments of the invention and that modifications may be made without departing from the spirit and scope of the invention as set forth in the following claims.

We claim:

1. An apparatus comprising:
a mother board;
a memory slot on the mother board;
a thermal sensor detecting temperature of a memory module in the memory slot, wherein the thermal sensor is disposed on the motherboard;
an embedded controller monitoring temperature from the thermal sensor; and
a memory controller adapted to receive data from the embedded controller.

2. The apparatus of claim 1, wherein the data that the memory controller received comprises temperature data from the embedded controller.

3. The apparatus of claim 2, wherein the memory controller compares the received temperature data to a trip point.

4. The apparatus of claim 3, wherein the trip point is calculated based on memory module information.

5. The apparatus of claim 4, wherein the memory module information comprises at least one of memory type, size, frequency, source of vendor, platform, and distance between the memory slots.

6. The apparatus of claim 3, wherein the trip point is calculated based on thermal sensor information.

7. The apparatus of claim 6, wherein the thermal sensor information comprises at least one of the thermal sensor type, size, frequency, source of vendor, platform, and distance between the memory slots and the thermal sensor.

8. The apparatus of claim 3, wherein the trip point is calculated based on a base trip point.

9. The apparatus of claim 8, wherein the base trip point is measured on an actual system.

10. A method comprising:
retrieving memory slot information;
computing at least one temperature threshold value for a memory module in a memory slot, the temperature threshold based on the retrieved memory slot information; and
regulating bandwidth of memory access for the memory module based on the temperature threshold value.

11. The method of claim 10 further comprising collecting temperature data of the memory module on the memory slot.

12. The method of claim 11 further comprising relaying the collected temperature data to a memory controller.

13. The method of claim 12 further comprising storing the collected temperature data in the memory controller.

14. The method of claim 13 further comprising comparing the collected temperature data to the computed temperature threshold value.

15. The method of claim 10 further comprising monitoring the collected temperature data of the thermal detector at a predetermined time period.

16. A computing device comprising:
a mother board;
a basic input/output system (BIOS) disposed on the mother board; and
a memory controller adapted to receive data, from the BIOS, regarding a quantity and a quality of memory installed in the computing device, the memory controller adapted to regulate bandwidth of memory access of the memory module.

17. The computing device of claim 17, wherein the mother board further comprises:
a memory slot;
a thermal sensor detecting temperature of a memory module in the memory slot; and
an embedded controller monitoring temperature from the thermal sensor.

18. The computing device of claim 18, wherein the thermal sensor is a temperature sensor.

19. The computing device of claim 19, wherein the BIOS initializes the memory controller and the embedded controller during a power-on self test (POST).

20. The computing device of claim 19, wherein the BIOS sets a trip point during the POST.
